(19) United States
(12) Patent Application Publication
(10) Pub. No.: US 2010/0146791 A1
(43) Pub. Date: Jun. 17, 2010

(54) Blade Assembly for Electric Razor

(76) Inventor: Tae-jun Oh, Namyangju-si (KR)

Correspondence Address: SWANSON & BRATSCHUN, L.L.C., 8210 SOUTHPARK TERRACE, LITTLETON, CO, 80120, US

(21) Appl. No.: 12/640,999

(22) Filed: Dec. 17, 2009

(30) Foreign Application Priority Data
Dec. 17, 2008 (KR) 20-2008-0016739

(51) Int. Cl. B26B 19/38

(52) U.S. Cl. 30/34.1

(57) ABSTRACT

Provided is a blade assembly for an electric razor including a housing 10 formed with an ON/OFF switch 12 on a front surface thereof; a driving part placed in an inside of the housing 10 and provided with a motor driven by electric power applied by the ON/OFF switch 12; a blade assembly having a blade rotated by the driving part; a mesh screen 20 for fixing the blade assembly; and a cover 30 removably fitted on an upper portion of the mesh screen 20, wherein the blade assembly S comprises: an outer mesh body 100 bended along a periphery of the blade assembly in a comb-shape so as to thrust up body hairs laid down on an area to be shaved and formed with a plurality of cutting slits 130 and a plurality of cutting holes 140 that come into contact with the area to be shaved to guide the body hairs; and a cutting blade 200 rotatably connected to the driving part, placed in an inside of the outer mesh body 100 and provided with a first cutting blade 210 for cutting the body hairs guided through the plurality of the cutting slits 130 and a second cutting blade 220 formed overlappedly with the first cutting blade 210, for cutting the body hairs guided through the plurality of the cutting holes 140.

### CROSS-REFERENCE(S) TO RELATED APPLICATIONS

The present invention claims priority of Korean Utility Model Application No. 20-2008-0016739, filed on Dec. 17, 2008, which is incorporated herein by reference.

### BACKGROUND OF THE INVENTION

1. Field of the Invention

The present invention relates to a blade assembly for an electric razor, and more particularly, to a blade assembly for an electric razor, in which an outer periphery of an outer mesh body is formed in a comb shape and thus body hairs laid down close to an area to be shaved are easily guided towards a cutting blade in an inside of the outer mesh body when shaving the area such as a face with many curved surfaces, a plurality of comb projections are formed along a circumference on an upper portion of the blade assembly to guide again the body hairs which are not yet cut to the inside of the outer mesh body, and the cutting blade in the outer mesh body is configured in a dual structure, thereby capable of performing more clean shaving to raise shaving effect; and each part is formed in a single body thereby capable of easily assembling and disassembling the blade assembly and saving cost for maintenance.

2. Description of Related Art

In general, an electric razor is largely classified into a trimmer type electric razor that shaves hairs with reciprocating blades and a rotary type electric razor that shaves hairs with rotating blades. Such conventional electric razor includes a cutting head and a body.

The cutting head is generally provided with a mesh screen that covers the cutting blades, to allow safe shaving. In such conventional electric razor, the cutting head provided with the mesh screen comes, after removal of a cap on the cutting head of the razor, into contact with an area to be shaved to perform the shaving.

The cutting head of the latter of the conventional electric razor, i.e. the rotary type electric razor is provided with cutting blades which rotates by rotation power transferred from a motor to cut body hairs on an area to be shaved and a outer mesh body formed with a plurality of cutting hole for guiding the body hair on the area to be shaved towards the cutting blades therethrough to perform the shaving not through direct contact of the cutting blades with the shaving area but through indirect contact of the cutting blades with the shaving area.

However, the outer mesh body of the cutting head of the conventional rotary type electric razor is formed in a cylindrical shape, in which a plurality of cutting holes are concentrically formed on an central upper surface of the outer mesh body and a plurality of cutting slits around the plurality of the cutting holes so that the body hairs on the area to be shaved are guided towards the cutting blades through the plurality of the cutting holes and the cutting slits and then cut.

Such outer mesh body of the conventional rotary type electric razor can excellently cut the body hairs on the area to be shaved when the body hairs are outwardly projected since the body hairs can be easily guided through the cutting holes and cutting slits, but can hardly cut the body hairs when the body hairs lie closely on the area to be shaved since the body hairs can be hardly guided through the cutting holes and cutting slits. That is, in the conventional rotary type electric razor, the body hairs can be easily guided through the cutting hole or cutting slit to be cut only when the body hairs are stood perpendicular to the plane of the cutting hole or cutting slit, and when the body hairs lie on the plane parallel with the cutting hole or cutting slit, there is a problem that it is hard for the body hairs to be guided towards the cutting hole or cutting slit and the shaving is not clearly performed.

Therefore, there are a troublesomeness that the user thrusts his/her body hairs up with his/her hand to allow the body hair to be easily guided through the cutting hole or cutting slit of the outer mesh body and a problem that it takes much time and effort since the shaving is not clearly performed and thus should be performed continuously for a long time.

### SUMMARY OF THE INVENTION

An aspect of the present invention, to solve the above problems, is to provide a blade assembly, in which a comb part is formed in a comb shape by bending outer periphery of an outer mesh body formed with a cutting slit and a comb projection is formed by bending a central circumference on an upper surface of the outer mesh body and thus body hairs laid down on an area to be shaved is thrust up as like as hair combing to be easily guided towards a cutting blade, thereby capable of excellently cutting the body hair on the area to be shaved and performing clean shaving with one time shaving. Another aspect of the present invention is to provide a blade assembly in which the cutting blade has different rotation diameters so as to correspond to the bent shape of the outer mesh body and a cutting blade of a dual structure is formed and thus laid down body hairs and outwardly projected body hairs on the area to be shaved can be simultaneously cut, thereby capable of performing easy and clean shaving in a short time.

To achieve the above and other aspects, the present invention provides a blade assembly for an electric razor including a housing 10 formed with an ON/OFF switch 12 on a front surface thereof; a driving part placed in an inside of the housing 10 and provided with a motor driven by electric power applied by the ON/OFF switch 12; a blade assembly S having a blade rotated by the driving part; a mesh screen 20 for fixing the blade assembly; and a cover 30 removably fitted on an upper portion of the mesh screen 20, wherein the blade assembly S comprises: an outer mesh body 100 bended along a periphery of the blade assembly in a comb-shape so as to thrust up body hairs laid down on an area to be shaved and formed with a plurality of cutting slits 130 and a plurality of cutting holes 140 that come into contact with the area to be shaved to guide the body hairs; and a cutting blade 200 rotatably connected to the driving part, placed in an inside of the outer mesh body 100 and provided with a first cutting blade 210 for cutting the body hairs guided through the plurality of the cutting slits 130 and a second cutting blade 220 formed overlappedly with the first cutting blade 210, for cutting the body hairs guided through the plurality of the cutting holes 140. The outer mesh body 100 is formed with a comb part 110 formed radially by bending between adjacent cutting slits 130; a comb projection 120 formed radially in plural and upwardly projected by bending a circumference between the cutting slit 130 and the cutting hole 140.

The blade assembly is formed so that the first cutting blade 210 is placed below the cutting slit 130 to cut the body hairs guided through the cutting slit 130, and the cutting slit 130 includes a first cutting slit 132 slit extendingly to below the outer periphery of the comb part 110 and a second cutting slit 134 slit extendingly from a side of the first cutting slit 132 to a side of the comb part 120. Further, the first cutting blade 210 is formed in a position corresponding to a diameter D2 so as to cut the body hair guided thereto through the first cutting slit 132 and in a position corresponding to a diameter D1 so as to cut the body hair guided thereto through the second cutting slit 134.

In accordance with the present invention, there are advantages that a comb part is formed in a comb shape by bending outer periphery of an outer mesh body formed with a cutting slit and a comb projection is formed by bending a central circumference on an upper surface of the outer mesh body and thus body hairs laid down on an area to be shaved is thrust up as like as hair combing to be easily guided towards a cutting blade, thereby capable of excellently cutting the body hair on the area to be shaved and performing clean shaving with one time shaving. Also, in accordance with the present invention, there are advantages that the cutting blade has different rotation diameters so as to correspond to the bent shape of the outer mesh body and a cutting blade of a dual structure is formed and thus laid down body hairs and outwardly projected body hairs on the area to be shaved can be simultaneously cut, thereby capable of performing easy and clean shaving in a short time.

### BRIEF DESCRIPTION OF THE DRAWINGS

FIG. 1 is a perspective view illustrating a blade assembly for an electric razor in accordance with an embodiment of the present invention.

FIG. 2 is a partially exploded perspective view illustrating the blade assembly for an electric razor in accordance with an embodiment of the present invention.

FIG. 3 is a partial side-sectional view illustrating the blade assembly for an electric razor in accordance with an embodiment of the present invention.

FIG. 4 is a partially enlarged perspective view illustrating the blade assembly for an electric razor in accordance with an embodiment of the present invention.

FIG. 5 is a partially enlarged side-sectional view illustrating the blade assembly for an electric razor in accordance with an embodiment of the present invention.

FIG. 6 is a side-sectional view illustrating a use of the blade assembly for an electric razor in accordance with an embodiment of the present invention.

FIG. 7 is a side-sectional view illustrating a use of a blade assembly for an electric razor in accordance with another embodiment of the present invention.

[Detailed Description of Main Elements]

| | |
|---|---|
| 100: outer mesh body | 110: comb part |
| 120: comb projection | 130: cutting slit |
| 132: first cutting slit | 134: second cutting slit |
| 140: cutting hole | 200: razor blade |
| 210: first cutting blade | 220: second cutting blade |

### DESCRIPTION OF SPECIFIC EMBODIMENTS

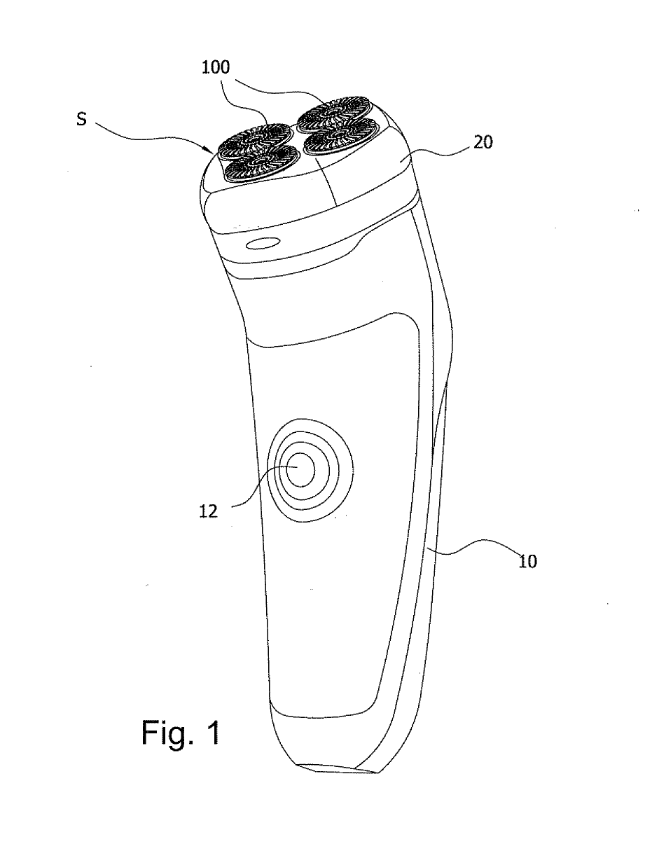

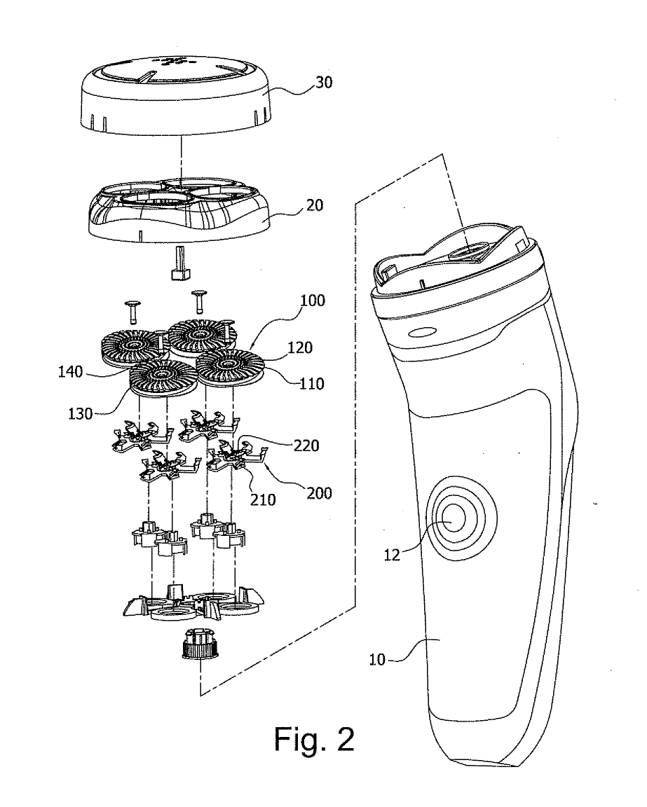

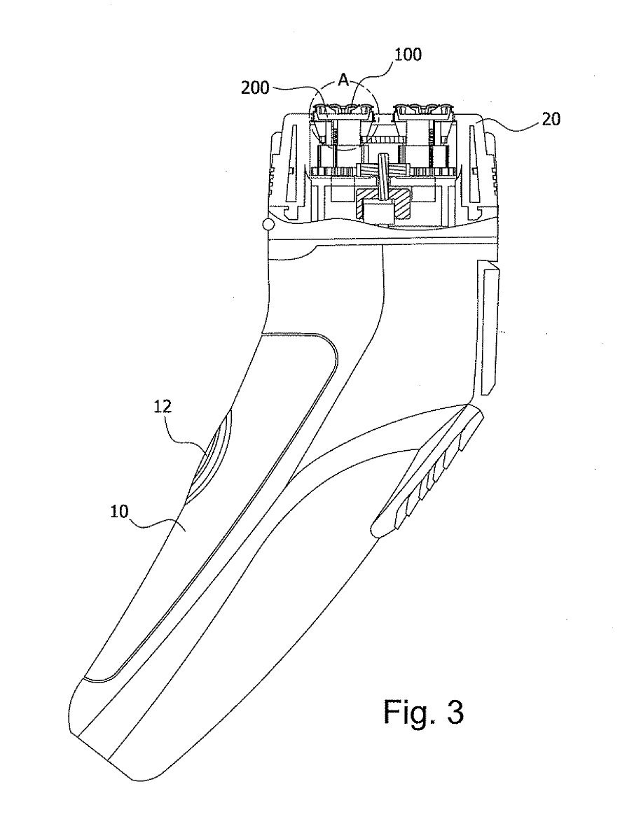

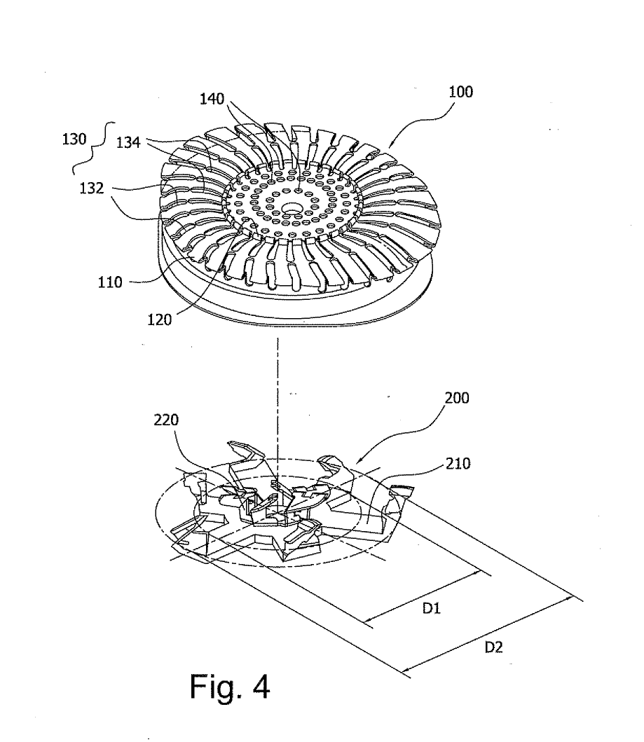

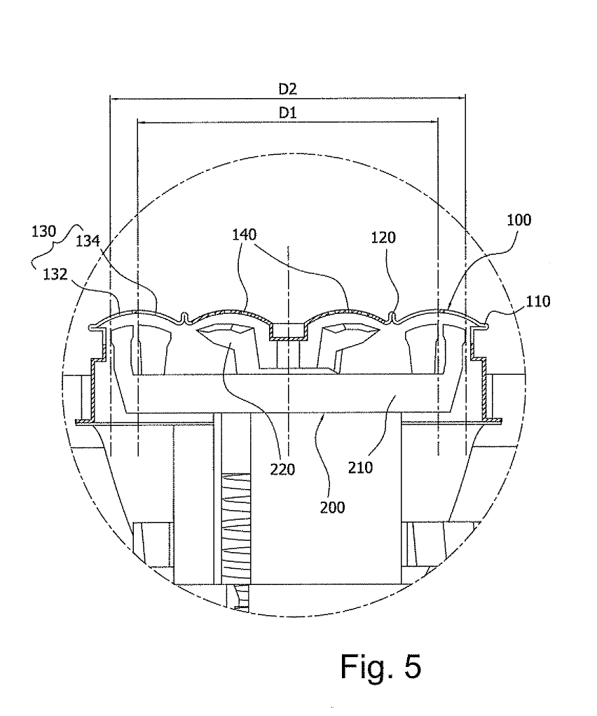

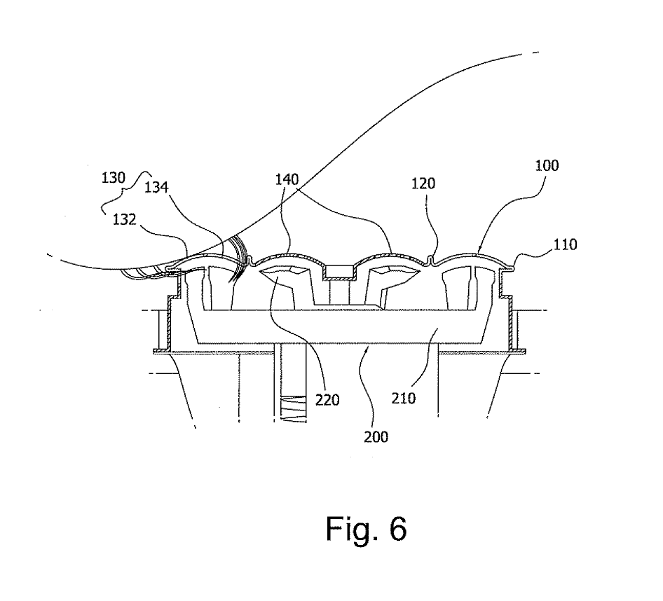

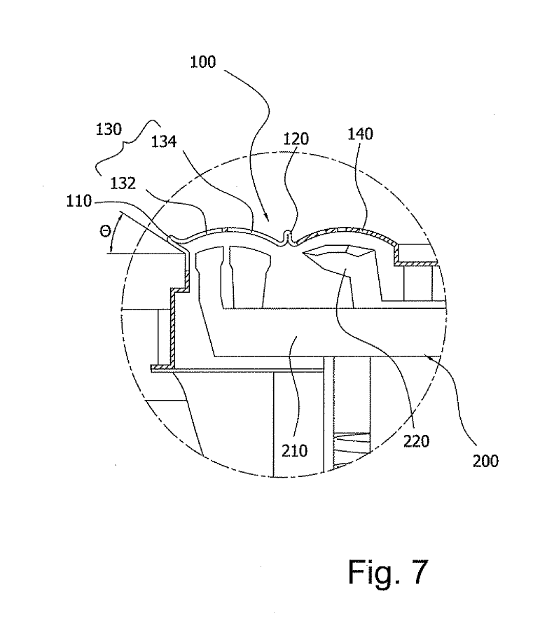

The advantages, features and aspects of the invention will become apparent from the following description of the embodiments with reference to the accompanying drawings, which is set forth hereinafter. FIG. 1 is a perspective view illustrating a blade assembly for an electric razor in accordance with an embodiment of the present invention; FIG. 2 is a partially exploded perspective view illustrating the blade assembly for an electric razor in accordance with an embodiment of the present invention; FIG. 3 is a partial side-sectional view illustrating the blade assembly for an electric razor in accordance with an embodiment of the present invention; FIG. 4 is a partially enlarged perspective view illustrating the blade assembly for an electric razor in accordance with an embodiment of the present invention; FIG. 5 is a partially enlarged side-sectional view illustrating the blade assembly for an electric razor in accordance with an embodiment of the present invention; FIG. 6 is a side-sectional view illustrating a use of the blade assembly for an electric razor in accordance with an embodiment of the present invention; and FIG. 7 is a side-sectional view illustrating a use of a blade assembly for an electric razor in accordance with another embodiment of the present invention.

As illustrated in FIGS. 1 through 4, a conventional electric razor 10 is configured such that a motor of a driving part mounted in an inside of a housing 10 rotates by electric power applied by an ON/OFF switch 12 placed on a front surface of the housing 10 and a cutting blade of a blade assembly fixed by a mesh screen 20 rotates by rotating force transferred from the motor to cut body hairs, and a cover 30 is fitted on the blade assembly to protect the blade assembly from external contaminants upon custody. A detailed description of the housing 10, the driving part, a mesh screen, a cover of the conventional electric razor 10 will be omitted. Here, the conventional blade assembly is replaced with a blade assembly S for an electric razor in accordance with an embodiment of the present invention, and the blade assembly includes an outer mesh body 100 and a cutting blade 200. The outer mesh body 100 raises body hairs on an area to be shaved by outwardly thrusting the body hairs up to facilitate cutting of the body hairs, and includes a comb part 110, a comb projection 120, a cutting slit 130 and a cutting hole 140.

The comb part 110 thrusts up the body hair laying down on the area to be shaved as like as hair combing, and is formed radially by press bending between adjacent cutting slits 130, which will be described later, with a press. The comb projection 120, like the comb part 110, outwardly thrusts up the body hair laying down on the area to be shaved as like as hair combing, and is formed so as to be upwardly projected by press bending a circumference between the cutting slit 130 and the cutting hole 140, which will be described later, with a press. Here, the comb projection is provided radially in plural as like as the aforementioned comb part 110. Meanwhile, the comb part 110 and the comb projection 120 can be formed in a fan shape with spacings along the circumference, if necessary, and some portion can be formed separately.

The cutting slit 130 is formed so that the body hairs on the area to be shaved is guided inwardly and cut by the cutting blade 200, and functions as a space between teeth of a comb upon formation of the comb part 110 to facilitate the guidance of the body hairs. Herein, the cutting slit 130 is provided with a first cutting slit 132 and a second cutting slit 134. The first cutting slit 132 is formed at the outmost of the outer mesh body 100 and is slit extendingly to below the outer periphery of the aforementioned comb part 110. Here, as the first cutting slit 132 extends downwardly along the comb part 110, the first cutting slit 132 is placed in the same plane as the laid down body hairs when the outer mesh body 100 comes into contact with the area to be shaved, so that the laid down body hairs can easily guided towards the cutting blade 200 which will be described later. The second cutting slit 134 is formed between the first cutting slit 132 and the cutting hole 140 in the center of the outer mesh body 100 to cut the body hairs in the area to be shaved in which the body hairs are stood up in a general state, and is slit extendingly to a side of the comb part 120. The cutting hole 140 is formed in plural in the center of the outer mesh body 100 so that the body hairs in a general state is guided therein and cut.

The cutting blade 200 is provided in the inside of the aforementioned outer mesh body 100 and is connected to the driving part (not shown) so that it rotates by the rotation force transferred from the driving part to cut the body hair, and is provided with a first cutting blade 210 and a second cutting blade 220. The first cutting blade 210 cuts the body hair guided thereto through the plurality of the cutting slits 130, and is, as shown in FIG. 5, formed in a position corresponding to a diameter D2 so as to cut the body hair guided thereto through the first cutting slit 132 and in a position corresponding to a diameter D1 so as to cut the body hair guided thereto through the second cutting slit 134. Here, when the first cutting blades 210 are formed in the positions corresponding to diameters D2 and D1, they are alternately positioned in a sequence of D2-D1-D2-D1, in which the same number are positioned in each of D2 and D1, so as to prevent vibration due to the rotation force. The second cutting blade 220 cuts the body hairs in the general state, and is provided direct below the plurality of the cutting holes 140 so as to cut the body hairs guided thereto through the plurality of the cutting holes 140. Also, the second cutting blade 220 is overlappedly coupled on the central upper portion of the first cutting blade so that the first cutting blade 210 and the second cutting blade 220 are provided, in a form of a dual structure, in the inside of the outer mesh body 100.

Operation of the electric razor provided with the blade assembly in accordance with an embodiment of the present invention, which have the configuration described above, will be described. As shown in FIG. 6, a user first turns the ON/OFF switch 12 of the housing 10 to an ON state. After that, power is applied to the driving part by the ON/OFF switch 12, and the driving part generates the rotation force to rotate the cutting blade 200. After that, simultaneously with the rotation of the cutting blade 200 due to the power apply, the user moves the electric razor towards the area to be shaved to contact the outer mesh body 100 with the area to be shaved. At this time, the body hairs projected outwardly from the area to be shaved are generally easily guided into the cutting blade 200 through the cutting hole 140 and the cutting slit 130 and the cut.

When there are body hairs which is long and thus are laid down on the area to be shaved during the user performs the shaving, the user moves the outer mesh body 100 along the area to be shaved.

At this time, by the comb part 110 formed between the adjacent first cutting slits 132 of the cutting slits 130 of the outer mesh body 100, the laid down body hairs are guided towards the first cutting slit 132 as like as combing hairs and the guided body hairs are cut by the first cutting blade 210 of the cutting blade 200. Also, by using the plurality of the comb projections 120 upwardly formed near the second cutting slit 134, the user can guide the rest of the body hairs, which is not yet guided towards the comb part 110, again in a state that the outer mesh body 100 is in contact with the laid down body hairs along the area to be shaved, thereby capable of performing clean shaving.

Meanwhile, as the first cutting blades 210 are formed in plural in the positions D1 and D2 of different diameters, they can respond immediately with position changes of the first and second cutting slits 132, 134 and cut the body hairs, and as the second blade 220 is formed overlappedly on the first cutting blade 210, the rotation forces of the first and second cutting blades 210, 220 are generated simultaneously, which enables more clean shaving. As described above, since the electric razor combs the body hairs on the area to be shaved with the comb part 110 and the comb projection 120, as like as combing hairs with a comb, to easily guide the body hairs towards the cutting blade 200, the shaving can be cleanly performed and there is no troublesomeness of raising the laid down body hair and then shaving again the body hairs, and thus the shaving time can be shortened to save time of a busy modern person.

Meanwhile, as illustrated in FIG. 7, by forming the comb part 110 of the outer mesh body 110 so that it guides the body hairs in an angle of θ, the body hair on the area to be shaved can be guided more smoothly and thus be excellently cut, thereby capable of shaving the area to be shaved more cleanly. Here, the angle θ of the comb part 110 is 15 to 30° and is an optimum angle that guides the body hair smoothly towards the cutting blade as described above.

While the present invention has been described with respect to the specific embodiment, it will be apparent to those skilled in the art that various changes and modifications may be made without departing from the spirit and scope of the invention as defined in the following claims.

What is claimed is:

1. A blade assembly for an electric razor including a housing 10 formed with an ON/OFF switch 12 on a front surface thereof; a driving part placed in an inside of the housing 10 and provided with a motor driven by electric power applied by the ON/OFF switch 12; a blade assembly S having a blade rotated by the driving part; a mesh screen 20 for fixing the blade assembly; and a cover 30 removably fitted on an upper portion of the mesh screen 20, wherein the blade assembly S comprises: an outer mesh body 100 bended along a periphery of the blade assembly in a comb-shape so as to thrust up body hairs laid down on an area to be shaved and formed with a plurality of cutting slits 130 and a plurality of cutting holes 140 that come into contact with the area to be shaved to guide the body hairs; and a cutting blade 200 rotatably connected to the driving part, placed in an inside of the outer mesh body 100 and provided with a first cutting blade 210 for cutting the body hairs guided through the plurality of the cutting slits 130 and a second cutting blade 220 formed overlappedly with the first cutting blade 210, for cutting the body hairs guided through the plurality of the cutting holes 140.

2. The blade assembly of claim 1, wherein the outer mesh body 100 is formed with a comb part 110 formed radially by bending between adjacent cutting slits 130; a comb projection 120 formed radially in plural and upwardly projected by bending a circumference between the cutting slit 130 and the cutting hole 140.

3. The blade assembly of claim 2, wherein the blade assembly is formed so that the first cutting blade 210 is placed below the cutting slit 130 to cut the body hairs guided through the cutting slit 130, and the cutting slit 130 includes a first cutting slit 132 slit extendingly to below the outer periphery of the comb part 110 and a second cutting slit 134 slit extendingly from a side of the first cutting slit 132 to a side of the comb part 120.

4. The blade assembly of claim 1, wherein the first cutting blade 210 is formed in a position corresponding to a diameter D2 so as to cut the body hair guided thereto through the first cutting slit 132 and in a position corresponding to a diameter D1 so as to cut the body hair guided thereto through the second cutting slit 134.

5. The blade assembly of claim 2, wherein the first cutting blade 210 is formed in a position corresponding to a diameter D2 so as to cut the body hair guided thereto through the first cutting slit 132 and in a position corresponding to a diameter D1 so as to cut the body hair guided thereto through the second cutting slit 134.

6. The blade assembly of claim 3, wherein the first cutting blade 210 is formed in a position corresponding to a diameter D2 so as to cut the body hair guided thereto through the first cutting slit 132 and in a position corresponding to a diameter D1 so as to cut the body hair guided thereto through the second cutting slit 134.
